(19) United States
(12) Patent Application Publication
(10) Pub. No.: US 2025/0038272 A1
(43) Pub. Date: Jan. 30, 2025

(54) ALL-SOLID-STATE BATTERY

(71) Applicants: SAMSUNG ELECTRO-MECHANICS CO., LTD.; UNIST (ULSAN NATIONAL INSTITUTE OF SCIENCE AND TECHNOLOGY)

(72) Inventors: Hyun-Wook Lee, Ulsan (KR); Minsoo Kim, Suwon-si, Gyeonggi-do (KR); Taehoon Kim, Suwon-si, Gyeonggi-do (KR); Namgyu Kim, Suwon-si, Gyeonggi-do (KR)

(73) Assignees: SAMSUNG ELECTRO-MECHANICS CO., LTD., Suwon-si, Gyeonggi-do (KR); UNIST (ULSAN NATIONAL INSTITUTE OF SCIENCE AND TECHNOLOGY), Ulsan (KR)

(21) Appl. No.: 18/280,584

(22) PCT Filed: Apr. 20, 2023
(86) PCT No.: PCT/KR2023/005363

§ 371 Date: Sep. 6, 2023

(30) Foreign Application Priority Data
Dec. 8, 2022 (KR) 10-2022-0170585

(51) Int. Cl. H01M 10/0585; H01M 4/36; H01M 10/0562

(52) U.S. Cl. CPC H01M 10/0585; H01M 4/366; H01M 10/0562; H01M 2300/0068

(57) ABSTRACT

An all-solid-state battery has opposing first and second side surfaces and includes: a first unit cell including a first positive electrode active material layer including a first margin layer in one side direction close to the first side surface, a second negative electrode active material layer including a second margin layer in the one side direction and the other side direction, and a solid electrolyte layer disposed between the active material layers; and a second unit cell including a second positive electrode active material layer including a second margin layer in the one side direction and the other side direction, a first negative electrode active material layer including a first margin layer in the other side direction close to the second side surface, and a solid electrolyte layer disposed between the active material layers. The first unit cell and the second unit cell are connected in series.

### TECHNICAL FIELD

The present disclosure relates to an all-solid-state battery.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ion conductivity (10⁴ S/cm to 10⁶ S/cm) than a sulfide electrolyte (10² S/cm) requires a high-temperature sintering process but exhibits excellent stability, compared with a sulfide all-solid-state battery using the sulfide electrolyte which reacts oxygen and moisture in the air.

A stacked oxide all-solid-state battery is a micro-sized battery and thus may be mounted on a substrate like a passive device, and in addition, is stable even though exposed at a high temperature in a reflow process for this.

### DISCLOSURE OF INVENTION

### Technical Problem

One aspect of the embodiment provides an all-solid-state battery capable of implementing a high-voltage battery.

However, example embodiments of the present invention are not limited thereto but may be applied in various ways within the scope of the technical idea included therein.

### Solution to Problem

An all-solid-state battery according to an embodiment has first and second side surfaces facing each other, and includes: a first unit cell including a first positive electrode active material layer including a first margin layer in one side direction close to the first side surface, a second negative electrode active material layer including a second margin layer in the one side direction and the other side direction, and a solid electrolyte layer disposed between the first positive electrode active material layer and the second negative electrode active material laver in a stacking direction; and a second unit cell including a second positive electrode active material layer including a second margin layer in one side direction and the other side direction, a first negative electrode active material layer including a first margin layer in the other side direction close to the second side surface, and a solid electrolyte layer disposed between the second positive electrode active material layer and the first negative electrode active material layer in the stacking direction. The first unit cell and the second unit cell are connected in series.

The second negative electrode active material layer of the first unit cell and the second positive electrode active material layer of the second unit cell may be disposed adjacent to each other in the stacking direction with an internal current collecting layer interposed therebetween.

The internal current collecting layer may include second margin layers in the one side direction and the other side direction.

The second margin layers may be disposed along an edge of one or more of the second positive electrode active material layer, the second negative electrode active material layer, and the internal current collecting layer.

An average length in the one side direction of the first margin layer of the first positive electrode active material layer may be longer than an average length in the one side direction of the second margin layer of the second negative electrode active material layer.

A ratio of the average length in the one side direction of the first margin layer of the first positive electrode active material layer to the average length in the one side direction of the second margin layer of the second negative electrode active material layer may be 1.2:1 to 2:1.

An average length in the other side direction of the first margin layer of the first negative electrode active material layer may be longer than an average length in the other side direction of the second margin layer of the second positive electrode active material layer.

A ratio of the average length in the other side direction of the first margin layer of the first negative electrode active material layer to the average length in the other side direction of the second margin layer of the second positive electrode active material layer may be 1.2:1 to 2:1.

The first margin layer and the second margin layer may have ionic conductivity of less than or equal to 1.0×10¹⁰ S/cm.

The first margin layer and the second margin layer may include an electrolyte material or an insulating material.

The solid electrolyte layer may include an inorganic solid electrolyte including an oxide-based solid electrolyte, a sulfide-based solid electrolyte, or a combination thereof.

An all-solid-state battery may further include a third unit cell including a second positive electrode active material layer including a second margin layer in the one side direction and the other side direction, a second negative electrode active material layer including a second margin layer in the one side direction and the other side direction, and a solid electrolyte layer disposed between the second positive electrode active material layer and the second negative electrode active material layer in the stacking direction, and the third unit cell may be disposed between the first unit cell and the second unit cell.

The third unit cell may be serially connected to the first unit cell and the second unit cell, respectively.

The all-solid-state battery may further include a first external electrode disposed on the second side surface and a second external electrode disposed on the first side surface.

The all-solid-state battery may further include a current collecting layer disposed adjacent to the first positive electrode active material layer in the stacking direction. The current collecting layer may extend in one side direction and be connected to the second external electrode. The all-solid-state battery may further include another current collecting layer disposed adjacent to the first negative electrode active material layer in the stacking direction. The current collecting layer may extend in one side direction and be connected to the first external electrode.

An all-solid-state battery according to another embodiment has first and second side surfaces facing each other, and includes: a first unit cell including a first positive electrode active material layer including a first margin layer in one side direction close to the first side surface, a second negative electrode active material layer including a second margin layer in the one side direction and the other side direction, and a solid electrolyte layer disposed between the first positive electrode active material layer and the second negative electrode active material layer in a stacking direction; and a second unit cell including a second positive electrode active material layer including a second margin layer in the one side direction and the other side direction, a first negative electrode active material layer including a first margin layer in the other side direction close to the second side surface, and a solid electrolyte layer disposed between the second positive electrode active material layer and the first negative electrode active material layer in the stacking direction wherein the all-solid-state battery includes two or more unit cells in which the first unit cell and the second unit cell are connected in series.

The unit cells may be connected in parallel.

In the unit cells, each of the first positive electrode active material layers may be disposed adjacent to each other in the stacking direction with a current collecting layer interposed therebetween.

In the unit cells, each of the first negative electrode active material layers may be disposed adjacent to each other in the stacking direction with a current collecting layer interposed therebetween.

The first positive electrode active material layers of each of the unit cells may be wider than the current collecting layer and may be connected to each other while surrounding an edge of the current collecting layer.

The first negative electrode active material layers of each of the unit cells may be wider than the current collecting layer and may be connected to each other while surrounding an edge of the current collecting layer.

In the unit cells, each of the first positive electrode active material layers may be disposed adjacent to each other in the stacking direction.

In the unit cells, each of the first negative electrode active material layers may be disposed adjacent to each other in the stacking direction.

An all-solid-state battery according to another embodiment has first and second external electrodes spaced apart from each other, and one or more unit cells, each including: an internal current collecting layer spaced apart from the first and second externa electrodes; a second negative electrode active material layer disposed on one surface of the internal current collecting layer, a second positive electrode active material layer disposed on another surface of the internal current collecting layer opposing the one surface of the internal current collecting layer, a first solid electrolyte layer, a first positive electrode active material layer, and a first current collecting layer sequentially disposed on the second negative electrode active material layer; and a second solid electrolyte layer, a first negative electrode active material layer, and a second current collecting layer sequentially disposed on the second positive electrode active material layer. The first current collecting layer may be connected to the first external electrode, and the second current collecting layer may be connected to the second external electrode. The internal current collecting layer may be closer to the first external electrode than the second current collecting layer, and may be closer to the second external electrode than the first current collecting layer.

The one or more unit cells includes a first unit cell and a second unit cell stacked on each other such that the second current collecting layer of the first unit cell is the same as the second current collecting layer of the second unit cell.

Each unit cell may further include: another solid electrolyte layer, another positive electrode active material layer, and another internal current collecting layer sequentially disposed between the second positive electrode active material layer and the second solid electrolyte layer. The another internal current collecting layer may be spaced apart from the first and second externa electrodes.

The second current collecting layer may include one end connected to the second external electrode and another end, opposing the one end, covered by the first negative electrode active material layer.

### Advantageous Effects of Invention

According to the all-solid-state battery according to the embodiment, a high-voltage battery may be implemented.

In addition, by overcoming the limitations of material combinations caused by reactivity between materials or simultaneous sintering conditions, a range of material selection may be expanded, and battery stability and process margins may be widened.

### BRIEF DESCRIPTION OF DRAWINGS

FIG. 1 is a schematic cross-sectional view of an all-solid-state battery according to an embodiment.

FIG. 2 is an exploded perspective view schematically illustrating a unit cell stack structure of an all-solid-state battery according to the embodiment shown in FIG. 1.

FIG. 3 is a schematic cross-sectional view of an all-solid-state battery according to another embodiment.

FIG. 4 is a schematic cross-sectional view of an all-solid-state battery according to another embodiment.

FIG. 5 is a schematic cross-sectional view of an all-solid-state battery according to another embodiment.

FIG. 6 is a schematic cross-sectional view of an all-solid-state battery according to another embodiment.

FIG. 7 is a schematic cross-sectional view of an all-solid-state battery according to another embodiment.

FIG. 8 is a schematic cross-sectional view of an all-solid-state battery according to another embodiment.

### MODE FOR THE INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification.

Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise,” and variations such as “comprises” or “comprising,” will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction,” which corresponds to an L-axis direction in the drawing.

Hereinafter, various embodiments and modifications will be described in detail with reference to the drawings.

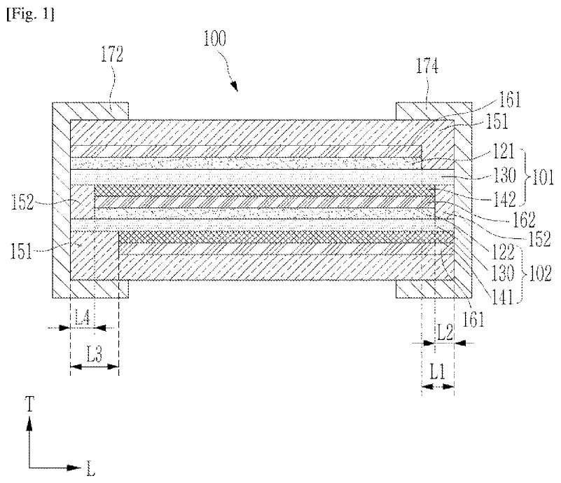

FIG. 1 is a schematic cross-sectional view of an all-solid-state battery according to an embodiment.

Referring to FIG. 1, the all-solid-state battery 100 may have, for example, an approximate hexahedral shape.

In the present example embodiment, for convenience of description, in the all-solid-state battery 100, both surfaces facing each other in a thickness direction (T-axis direction) are defined as first and second surfaces, and both surfaces connected to the first and second surfaces and facing each other in a length direction (L-axis direction) are defined as third and fourth surfaces. For example, the first and second side surfaces of the all-solid-state battery 100 may be the third and fourth surfaces.

The all-solid-state battery 100 according to the present embodiment includes a first unit cell 101 and a second unit cell 102.

The first unit cell 101 includes a first positive electrode active material layer 121, a second negative electrode active material layer 142, and a solid electrolyte layer 130 disposed between the first positive electrode active material layer 121 and the second negative electrode active material layer 142 in a stacking direction.

The second unit cell 102 includes a second positive electrode active material layer 122, a first negative electrode active material layer 141, and a solid electrolyte layer 130 disposed between the second positive electrode active material layer 122 and the first negative electrode active material layer 141 in a stacking direction.

The first positive electrode active material layer 121 may be formed by coating a positive electrode active material to one surface of the current collecting layer 161, and the first negative electrode active material layer 141 may be formed by coating a negative electrode active material to one surface of the current collecting layer 161.

In addition, the second positive electrode active material layer 122 may be formed by coating a positive electrode active material on one surface of the internal current collecting layer 162, and the second negative electrode active material layer 142 may be formed by coating the negative electrode active material on the other surface of the internal current collecting layer 162.

For example, the first positive electrode active material layer 121 at the uppermost end in the stacking direction is disposed on the lower surface of the current collecting layer 161, and the first negative electrode active material layer 141 at the lowermost end is disposed on the upper surface of another current collecting layer 161. In addition, in the case of the electrode layers between the uppermost and lowermost ends, the second positive electrode active material layer 122 and the second negative electrode active material layer 142 may be respectively disposed on both side surfaces of the internal current collecting layer 162.

For example, the positive electrode active material is not particularly limited as long as it can secure sufficient capacity of the all-solid-state battery 100. For example, positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<α<2); LiₐNi_{1-b-c}CO_{b}M_{c}O_{2-α}X₂ (wherein 0.90≤a≤1.8, 0≤b≤0.5, 0≤c<0.05, 0<α<2); LiₐNi_{1-b-c}Mn_{b}M_{c}D_{α} (wherein 0.90≤a≤1.8, 0≤b≥0.5, 0<c<0.05, 0<α<2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}M_{c}M_{c}O_{2-α}X₂ (wherein 0.90≤a≤1.8, 0<b≤0.5, 0≤c≤0.05, 0<α<2); LiₐNi_{b}E_{c}G_{d} O₂ (wherein 0.90≤a≤1.8, 0≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LIRO₂; LiNIVO₄; Li_{(3-f)}J₂(PO₄)₃ (0≤f≤2); Li_{(3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fc, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fc, Sc, or Y; and J is V, Cr, Mn, Co, Ni, or Cu.

The positive electrode active material may also be LiCoO₂, LiMnₓO₂ (wherein x=1 or 2). LiNi₁₋ₓMnₓO₂ₓ (wherein 0<x<1), LiNi_{1-x-y}CoₓMn_{y}O₂ (wherein 0≤x≤0.5, 0≤y≤0.5), LiFePO₄, TiS₂, FeS₂, TiS₃, or FeS₃.

The positive electrode active material layer may optionally include a conductive agent and a binder.

The conductive agent is not particularly limited as long as it has conductivity without causing chemical change in the all-solid-state battery 100. For example, examples of the conductive agent may include graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

A content of the conductive agent may be 1 part by weight to 10 parts by weight, for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, for example, 2 parts by weight to 5 parts by weight, based on 100 parts by weight of the total positive electrode active material. When the content of the binder satisfies the above range, the active material layer may have high bonding strength.

As the current collecting layer 161, a porous material such as a mesh or mesh shape may be used, and a porous metal plate such as stainless steel, nickel, or aluminum may be used. In addition, the current collecting layer 161 may be coated with an oxidation-resistant metal or alloy film to prevent oxidation.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, or a transition metal oxide such as lithium titanium oxide (L₄Ti₅O₁₂), a rare earth element, or a combination thereof, and Sn is not included), or MₙOₓ (0<x≤2).

The element Y may be Mg, Ca, Sr. Ba, Ra. Sc, Y, Ti, Zr, Hf, Rf, V, Nb, Ta, Dh, Cr, Mo, W, Sg. Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or mixtures thereof. The crystalline carbon may include graphite, such as natural graphite or artificial graphite in amorphous, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, a carbon nanotube, a carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, in, Ge, Pb, and Ti.

The negative electrode active material layer may also optionally include a conductive agent and a binder as described in the positive electrode active material layer.

The solid electrolyte layer 130 may be disposed between the first positive electrode active material layer 121 and the second negative electrode active material layer 142 and stacked, or may be disposed between the second positive electrode active material layer 122 and the first negative electrode active material layer 141 and stacked.

Therefore, the solid electrolyte layer 130 may be disposed adjacently between the first positive electrode active material layer 121 and the second negative electrode active material layer 142 in the stacking direction, and may be disposed adjacently between the second positive electrode active material layer 122 and the first negative electrode active material layer 141 in the stacking direction.

Accordingly, in the all-solid-state battery 100, a plurality of the positive electrode active material layers and a plurality of the negative electrode active material layers may be alternately disposed, and a plurality of the solid electrolyte layers may be interposed and stacked therebetween. The all-solid-state battery 100 is a multilayered solid-state battery 100 manufactured by alternately stacking a plurality of positive electrode active material layers and negative electrode active material layers, and interposing a plurality of solid electrolyte layers therebetween to provide a cell stack, and then firing them collectively.

The solid electrolyte layer 130 may include an inorganic solid electrolyte including an oxide-based solid electrolyte, a sulfide-based solid electrolyte, or a combination thereof.

The oxide-based solid electrolyte may be a garnet-type, NASICON-type, LISICON-type, perovskite-type, LiPON-type, or amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₃₊ₓAlₓTi₂₋ₓ(PO₄)₃ (0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₃₊ₓAlₓGe₂₋ₓ(PO₄)₃ (0<x<1) such as Li₃Al_{0.3}Ti_{1.7}(PO₄)₃ introduced with excess lithium and/or lithium-zirconium-phosphate (LZP) of LiZr₂(PO₄)₃.

In addition, the LISICON-based solid electrolyte may be include a solid solution oxide represented by xLi₃AO₄-(1-x)Li₄BO₄ (wherein A is P, As, or V and B is Si, Ge, or Ti) such as Li₄Zn(GeO₄)₄, Li₁₀GeP₂O₁₂(LGPO), Li_{3.5}Si_{0.5}P_{0.5}O₄, or Li_{10.42}Si(Ge)_{1.5}P_{1.5}Cl_{0.08}O_{11.92}, or a solid solution sulfide represented by Li₄₋ₓM_{1-y}M′_{y}S₄ (wherein M is Si, or Ge and M is P, Al, Zn, or Ga) such as Li₂S—P₂S₅, Li₂S—SiS₂, Li₂S—SiS₂—P₂S₅, or Li₂S—GeS₂.

The perovskite-based solid electrolyte may include lithium lanthanum titanate (LLTO) represented by Li₃ₓLa_{2/3-x}□_{1/3-2x}TiO₃ (0<x<0.16, □: vacancy) such as Li_{1/8}La_{5/8}TiO₃. The LiPON-based solid electrolyte may include a lithium phosphorous oxynitride such as Li_{2.8}PO_{3.3}N_{0.46}.

Examples of the amorphous electrolyte include Li₂O—B₂O₃—SiO₂, Li₂O—B₂O—P₂O₅, Li₃BO₃—Li₂SO₄, or Li₃BO₃—Li₂CO₃.

The sulfide-based solid electrolyte may include a sulfur atom among electrolyte components and is not limited to a specific component, and may include one or more of a crystalline solid electrolyte, an amorphous solid electrolyte (glassy solid electrolyte), or a glass ceramic solid electrolyte.

For example, the sulfide-based solid electrolyte may include an LPS-type sulfide containing sulfur and phosphorus (e.g., Li₂S—P₂S₅), or a thio-LISICON-based compound Li₄₋ₓGe₁₋ₓPₓS₄ (x is 0.1 to 2, or x is ¾, or ⅔), Li_{10±1}MP₂X₁₇ (M is Ge, Si, Sn, or Al and X is S or Sc), Li_{3.833}Sn_{0.833}As_{0.166}S₄, Li₄SnS₆, Li_{3.25}Ge_{0.25}P_{0.75}S₄, Li₂S—P₂S₅, B₂S₃—Li₂S, xLi₂S-100-xP₂S₅ (x is 70 to 80), Li₂S—SiS₂—Li₃N, Li₂S—P₂S—LiI, Li₂S—SiS₂—LiI, Li₂S—B₂S₃—LiI, Li₁₀SnP₂S₁₂, or Li_{3.25}Ge_{0.25}P_{0.75}S₂.

The solid electrolyte may have ionic conductivity of greater than or equal to about 1×10⁻³ S/cm. The ionic conductivity may be measured at a temperature of 25° C. The ionic conductivity may be greater than or equal to 1×10⁻³ S/cm, 2×10⁻³ S/cm, greater than or equal to 3×10⁻³ S/cm, greater than or equal to 4×10⁻³ S/cm, or greater than or equal to 5×10⁻³ S/cm, of which an upper limit is not particularly limited. When a solid electrolyte satisfying the ranges of ionic conductivity is used, the all-solid-state battery 100 may exhibit high output.

A first margin layer 151 may be disposed along the edges of the first positive electrode active material layer 121 and the first negative electrode active material layer 141, while a second margin layer 152 may be disposed along the edges of the second positive electrode active material layer 122 and the second negative electrode active material layer 142.

The first margin layer 151 may be disposed on the solid electrolyte layer 130 adjacent to the edge of the first positive electrode active material layer 121 or the first negative electrode active material layer 141 in one side direction, and the second margin layer 152 may be disposed on the solid electrolyte layer 130 adjacent to the edge of the second positive electrode active material layer 122 or the second negative electrode active material layer 142 in one side direction.

Accordingly, the first margin layer 151 may be disposed on the same layer as the first positive electrode active material layer 121 or the first negative electrode active material layer 141, and the second margin layer 152 may be disposed on the same layer as the second positive electrode active material layer 122 or the second negative electrode active material layer 142.

The first margin layer 151 and the second margin layer 152 may include an insulating material having ionic conductivity of less than or equal to 1.0×10⁻¹⁰ S/cm, for example, include the aforementioned solid electrolyte material or an insulating material such as a resin.

For example, the insulating material may be a polyolefin such as polyethylene or polypropylene and the like, a polyester such as polyethylene terephthalate (PET) and the like, polyurethane, or polyimide.

In addition, the first margin layer 151 and the second margin layer 152 may include an inorganic solid electrolyte including an oxide-based solid electrolyte used in the solid electrolyte layer 130, a sulfide-based solid electrolyte, or a combination thereof. However, the first margin layer 151 and the second margin layer 152 are not limited thereto but may include various materials.

A first unit cell 101 including the first positive electrode active material layer 121, the solid electrolyte layer 130, and the second negative electrode active material layer 142 is stacked with a second unit cell 102 including the second positive electrode active material layer 122, the solid electrolyte layer 130, and the first negative electrode active material layer 141 to constitute a cell stack of the all-solid-state battery 100.

The first unit cell 101 and the second unit cell 102 may be connected in series.

Herein, the second negative electrode active material layer 142 of the first unit cell 101 and the second positive electrode active material layer 122 of the second unit cell 102 may be disposed adjacent to each other in a stacking direction with an internal current collecting layer 162 interposed therebetween.

A protective layer made of an insulating material may be formed on the upper and lower ends of the cell stack of the all-solid-state battery 100.

In addition, on both sides of the cell stack of the all-solid-state battery 100, a terminal of the current collecting layer 161 adjacent to the first positive electrode active material layer 121 and a terminal of the current collecting layer 161 adjacent to the first negative electrode active material layer 141 are respectively exposed, and first and second external electrodes 172 and 174 may be respectively connected and coupled to these exposed terminals. In other words, the first external electrode 172 may be configured to be connected to the terminal of the current collecting layer 161 adjacent to the first positive electrode active material layer 121 to form a positive electrode, while the second external electrode 174 may be configured to be connected to the terminal of the current collecting layer 161 adjacent to the first negative electrode active material layer 141 and form a negative electrode. The terminal of the current collecting layer 161 adjacent to the first positive electrode active material layer 121 and the terminal of the current collecting layer 161 adjacent to the first negative electrode active material layer 141 are configured to face each other in opposite directions, so that the first and second external electrodes 172 and 174 may also be disposed on both sides, respectively.

The first and second external electrodes 173 and 174 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the first and second external electrodes 172 and 174 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the first and second external electrodes 172 and 174 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

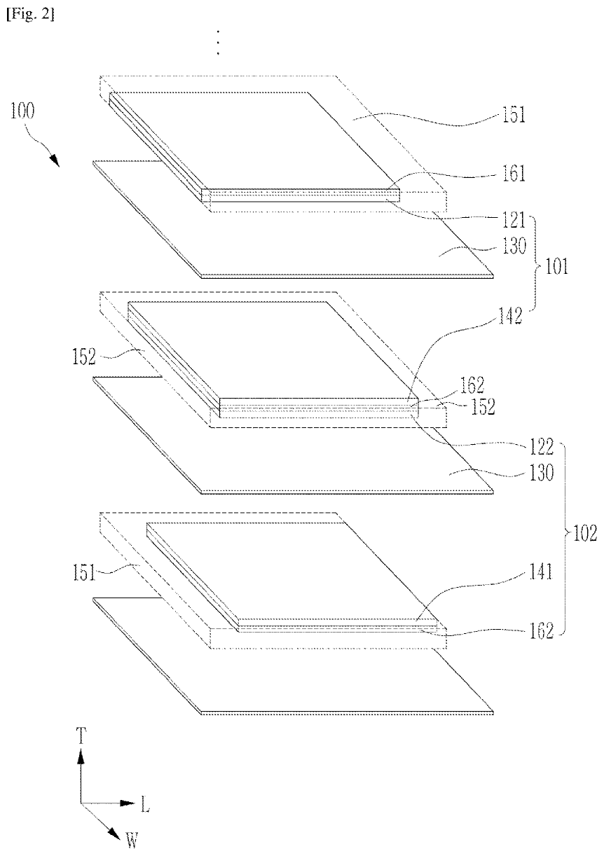

FIG. 2 is an exploded perspective view schematically illustrating a unit cell stack structure of the all-solid-state battery 100 according to the embodiment shown in FIG. 1.

Referring to FIG. 2, the first margin layer 151 may be disposed in one side direction close to the first side surface (third surface) of the first positive electrode active material layer 121. In addition, the first margin layer 151 may also be disposed in both side directions of the first positive electrode active material layer 121 in the W-axis direction. Accordingly, the first margin layer 151 may be disposed along the edge of the first positive electrode active material layer 121.

The first positive electrode active material layer 121 may extend to one side direction close to the second side surface (fourth surface), for example, to the end of one side direction close to the second side surface (fourth surface) of the solid electrolyte layer 130. Accordingly, the first margin layer 151 may not be disposed in one side direction close to the second side surface (fourth surface) of the first positive electrode active material layer 121.

The second margin layer 152 may be disposed in one side direction id the other side direction of the second negative electrode active material layer 142 in the L-axis direction. In addition, the second margin layer 152 may also be disposed on both side directions of the second negative electrode active material layer 142 in the W-axis direction. For example, the second negative electrode active material layer 142 does not extend to one side direction or the other side direction in the L-axis direction but may be disposed only in the central region of the solid electrolyte layer 130 excluding the edges. Accordingly, the second margin layer 152 may be disposed along all the edges of the second negative electrode active material layer 142.

Similarly, the second positive electrode active material layer 122 may be disposed on one side direction and the other side direction of the second margin layer 152 in the L-axis direction. In addition, the second margin layer 152 may also be disposed on both side directions of the second positive electrode active material layer 122 in the W-axis direction. For example, the second positive electrode active material layer 122 does not extend in one side direction or the other side direction of the L-axis direction but may be disposed only in the central region of the solid electrolyte layer 130 excluding the edges. Accordingly, the second margin layer 152 may be disposed at all the edges of the second positive electrode active material layer 122.

When the internal current collecting layer 162 is disposed between the second negative electrode active material layer 142 and the second positive electrode active material layer 122, the second margin layer 152 may also be disposed one side direction and the other side direction of the L-axis direction of the internal current collecting layer 162. In addition, the second margin layer 152 may be disposed at both side directions of the W-axis direction of the internal current collecting layer 162. For example, the internal current collecting layer 162 does not extend to one side direction or the other side direction of the L-axis direction but may be disposed only in the central region of the solid electrolyte layer 130 excluding the edges. Accordingly, the second margin layer 152 may be disposed along all the edges of the internal current collecting layer 162.

The all-solid-state battery 100 may include an internal electrode in which a second positive electrode active material layer 122, an internal current collecting layer 162, and a second negative electrode active material layer 142 are stacked. All edges of the internal electrode may be surrounded by the second margin layer 152. The internal electrode is located in the central region of the solid electrolyte layer 130 without being offset to either side, reducing mismatch between the positive and negative electrodes and thereby suppressing current concentration according to straight movement of Li ions along the T-axis direction.

On the other hand, the first margin layer 151 may be disposed in one side direction close to the second side surface (fourth surface) of the first negative electrode active material layer 141. In addition, the first margin layer 151 may also be disposed on both side directions of the first negative electrode active material layer 141 in the W-axis direction. Accordingly, the first margin layer 151 may be disposed along the edge of the first negative electrode active material layer 141.

The first negative electrode active material layer 141 may extend to one side direction close to the first side surface (third surface), for example, to the end of one side direction close to the first side surface (third surface) of the solid electrolyte layer 130. Accordingly, the first margin layer 151 may not be disposed in one side direction close to the first side surface (third surface) of the first negative electrode active material layer 141.

An average length L1 in one side direction (L-axis direction) of the first margin layer 151 close to the first side surface (third surface) may be longer than an average length L2 in one side direction (L-axis direction) of the second margin layer 152 close to the first side surface (third surface).

For example, a ratio of the average length L1 in one side direction (L-axis direction) of the first margin layer 151 close to the first side surface (third surface) and the average length 12 in one side direction (L-axis direction) of the second margin layer 152 close to the first side surface (third surface) may be 1.2:1 to 2:1, for example, 1.2:1 to 2:1, 1.5:1 to 2:1, 1.2:1 to 1.8:1, 1.5:1 to 1.8:1, 1.8:1 to 2:1, or 1.2:1 to 1.5:1.

Herein, a length of the first margin layer 151 may be determined by polishing the all-solid-state battery 100, until any first positive electrode active material layer 121 is exposed in a plane direction generally perpendicular to the T-axis direction, and obtaining a maximum length in one side direction (L-axis direction) of the first margin layer 151 close to the first side surface (third surface) of the exposed first positive electrode active material layer 121.

The average length L1 of the first margin layer 151 may be an arithmetic mean of lengths of any 3, 5, or 10 first margin layers 151 respectively disposed on the different first positive electrode active material layers 121.

In addition, a length of the second margin layer 152 may be determined by polishing the all-solid-state battery 100, until any second negative electrode active material layer 142 is exposed in a plane direction generally perpendicular to the T-axis direction, and obtaining a maximum length in one side direction (L-axis direction) of the first margin layer 151 close to the first side surface (third surface) of the exposed second negative electrode active material layer 142.

The average length L2 of the second margin layer 152 may be an arithmetic mean of lengths of any 3, 5, or 10 second margin layers 152 respectively disposed on the different second negative electrode active material layers 142.

When the average length L1 in one side direction (L-axis direction) close to the first side surface (third surface) of the first margin layer 151 is longer than the average length L2 in one side direction (L-axis direction) close to the first side surface (third surface) of the first second margin layer 152, as Li ions move straight along the T-axis direction, the current concentration may be severe, but the second negative electrode active material layer 142 is not shifted to one side but positioned in the central region of the solid electrolyte layer 130, reducing mismatch between positive and negative electrodes and suppressing the current concentration.

An average length L3 in one side direction (L-axis direction) of the first margin layer 151 may be longer than an average length L4 in one side direction close to the second side surface (fourth surface) of the second margin layer 152.

For example, a ratio of the average length L3 in one side direction (L-axis direction) close to the second side surface (fourth surface) of the first margin layer 151 and the average length L4 in one side direction (L-axis direction) close to the second side surface (fourth surface) of the second margin layer 152 may be 1.2:1 to 2:1, for example, 1.2:1 to 2:1, 1.5:1 to 2:1, 1.2:1 to 1.8:1, 1.5:1 to 1.8:1, 1.8:1 to 2:1, or 1.2:1 to 1.5:1.

Herein, a length of the first margin layer 151 may be determined by polishing the all-solid-state battery 100, until any first negative electrode active material layer 141 is exposed in a plane direction generally perpendicular to the T-axis direction, and obtaining a maximum length in one side direction (L-axis direction) of the first margin layer 151 close to the first side surface (third surface) of the exposed first negative electrode active material layer 141.

The average length L3 of the first margin layer 151 may be an arithmetic mean of lengths of any 3, 5, or 10 first margin layers 151 respectively disposed on the different first negative electrode active material layers 141.

In addition, a length of the second margin layer 152 may be determined by polishing the all-solid-state battery 100, until any second positive electrode active material layer 122 is exposed in a plane direction generally perpendicular to the T-axis direction, and obtaining a maximum length in one side direction (L-axis direction) of the second margin layer 152 close to the first side surface (third surface) of the exposed second positive electrode active material layer 122.

The average length L4 of the second margin layer 152 may be an arithmetic mean of lengths of any 3, 5, or 10 second margin layers 152 respectively disposed on the different second positive electrode active material layers 122.

When the average length L3 in one side direction (L-axis direction) of the first margin layer 151 close to the second side surface (fourth surface) is longer than the average length L4 in one side direction (L-axis direction) of the second margin layer 152 close to the second side surface (fourth surface). Li ions move straight along the T-axis direction. When the second positive electrode active material layer 122 is tilted to one side, there may be a severe current concentration, but since the second positive electrode active material layer 122 is not tilted to one side but is disposed in the central region of the solid electrolyte layer 130, the current concentration may be relaxed by reducing mismatch of the positive and negative electrodes.

According to the all-solid-state battery 100 according to the present embodiment, a high-voltage battery may be implemented. For example, when a LFP (LiFePO₄, 3.4 V) positive electrode active material is combined with a LTO (Li₄Ti₅O₁₂, 1.5 V) negative electrode active material, a low voltage of 1.9 V may be obtained in a unit cell, but a voltage of greater than or equal to 3.8 V may be obtained according to the number of serially connected unit cells manufactured by applying the all-solid-state battery 100.

In addition, when a LMO (LiMn₂O₄, 4.0 V). LCO (LiCoO₂, 3.8 V to 4.0 V), or LNMO (LiNi_{0.5}Mn_{0.3}O₄, 4.7 V) positive electrode active material is combined with a graphite (0.2 V) negative electrode active material, since a voltage of about 4.0 V may be obtained by a unit cell alone, three unit cells manufactured by using the all-solid-state battery 100 according to the present example embodiment are connected in series to obtain a 12 V or more battery.

In addition, since a material such as LVP, which may be used as both positive and negative electrode active materials (operation voltage: 3.6 V to 4.1 V and 1.7 V to 2.0 V), may obtain a maximum voltage of a unit cell of 2.9 V, a high-voltage battery may be manufactured by applying the all-solid-state battery 100 according to the present example embodiment.

Such an all-solid-state battery 100 may be operated by being directly mounted on a power supply unit of a substrate like a passive device. In addition, this all-solid-state battery 100 occupies a local region and thus may be mounted in a region with a desired shape, and in addition, several all-solid-state batteries 100 may be mounted, if necessary, as long as a space is allowed in a device.

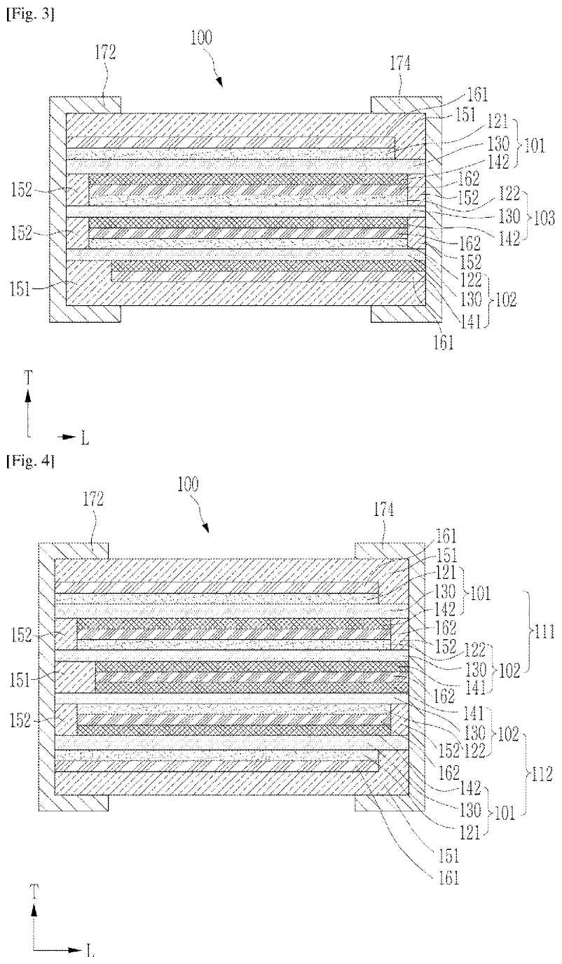

FIG. 3 is a schematic cross-sectional view of an all-solid-state battery according to another embodiment.

Since the all-solid-state battery according to the present embodiment is similar to the aforementioned all-solid-state battery, overlapping descriptions will be omitted and the descriptions will focus on the differences.

In the embodiment shown in FIG. 3, the all-solid-state battery 100 further includes a third unit cell 103 between the first unit cell 101 and the second unit cell 102.

The third unit cell 103 includes the second positive electrode active material layer 122 including the second margin layers 152 in one side direction and the other side direction of the L-axis direction, the second negative electrode active material layer 142 including second margin layers 152 in one side direction and the other side direction of the L-axis direction, and the solid electrolyte layer 130 disposed adjacent to each other between the second positive electrode active material layer 122 and the second negative electrode active material layer 142 in the stacking direction.

The third unit cell 103 may be connected in series with the first unit cell 101 and the second unit cell 102, respectively. Herein, the second negative electrode active material layer 142 of the first unit cell 101 and the second positive electrode active material layer 122 of the third unit cell 103 may be disposed adjacent to each other in the stacking direction with the internal current collecting layer 162 in the middle, and the second negative electrode active material layer 142 of the third unit cell 103 and the second positive electrode active material layer 122 of the second unit cell 102 may be disposed adjacent to each other in the stacking direction with the internal current collecting layer 162 in the middle.

In addition, the all-solid-state battery 100 may include a plurality of the third unit cells 103, and each third unit cell 103 may be connected in series to one another. In other words, in order to increase a voltage of the all-solid-state battery 100, as many third unit cells 103 as needed may be connected in series.

FIGS. 4 to 8 are schematic cross-sectional views of all-solid-state batteries according to example embodiments.

Since the all-solid-state battery according to the present embodiments is similar to the aforementioned all-solid-state battery, overlapping descriptions will be omitted and the descriptions will focus on the differences.

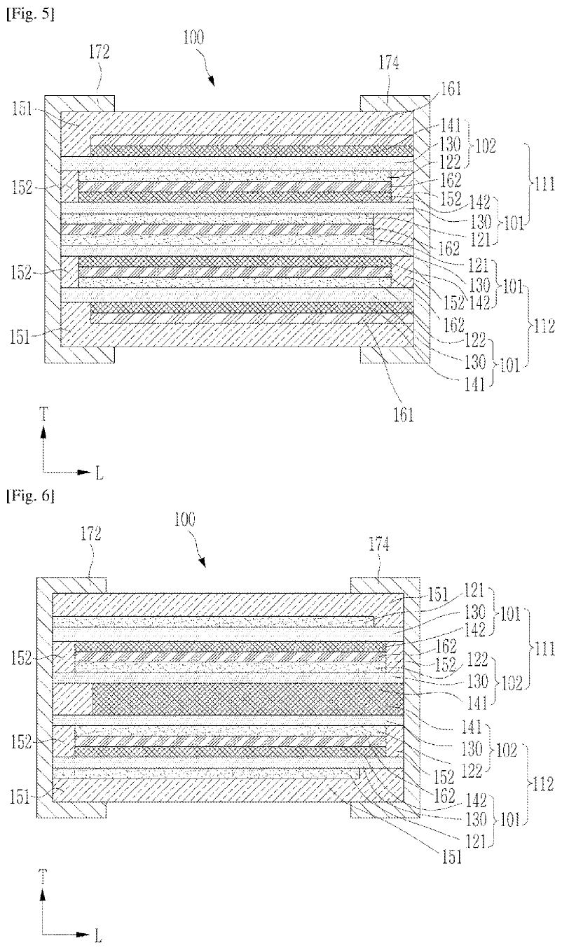

In the embodiment shown in FIGS. 4 and 5, the all-solid-state battery 100 includes first and second unit cells 111 and 112 in which a first unit cell 101 and a second unit cell 102 are connected in series.

The first and second unit cells 111 and 112 are connected in parallel.

FIG. 4 shows a case that the first and second unit cells 111 and 112 are connected in parallel by disposing the first negative electrode active material layers 141 of each unit cell adjacent to each other with the current collecting layer 161 interposed therebetween in the stacking direction.

FIG. 5 shows a case that the first and second unit cells 111 and 112 are connected in parallel by disposing the first positive electrode active material layers 121 of each unit cell adjacent to each other with the current collecting layer 161 interposed therebetween in the stacking direction.

FIG. 6 shows a case that the first and second unit cells 111 and 112 are connected in parallel by disposing the first negative electrode active material layers 141 of each unit cell adjacent to each other in the stacking direction. In FIG. 4, the first and second unit cells 111 and 112 are disposed adjacent to each other in the stacking direction by disposing the first negative electrode active material layers 141 of each unit cell with the current collecting layer 161 interposed therebetween, but in FIG. 6, the first and second unit cells 111 and 112 are disposed adjacent to each other in the stacking direction by disposing the first negative electrode active material layer 141 of each unit cell without the current collecting layer 161 interposed therebetween. Herein, the first negative electrode active material layer 141 of the first unit cell 111 and the first negative electrode active material layer 141 of the second unit cell 112 may be integrated so much so as to be substantially not distinguished.

In addition, as shown in FIG. 6, since the first and second unit cells 111 and 112 are connected in parallel by disposing the first positive electrode active material layers 121 adjacent to each other in the stacking direction, the first and second unit cells 111 and 112 may be connected in parallel by disposing the first positive electrode active material layers 121 adjacent to each other in the stacking direction without interposing the current collecting layer 161 therebetween.

When the current collecting layer is removed in a structure that either one of the positive and negative electrodes is tilted to one side, since the current concentration becomes more severe, the current collecting layer is difficult to remove. On the other hand, as in the present example embodiment, when an internal electrode, in which the second positive electrode active material layer 122, the internal current collecting layer 162, and the second negative electrode active material layer 142, are stacked is not tilted to one side in the L-axis direction but is disposed in the central region of the solid electrolyte layer 130, mismatch of the positive and negative electrodes may be reduced. Accordingly, since the current concentration according to straight movement of Li ions along the T-axis direction may be reduced, the current collecting layer may not be included in the present example embodiment.

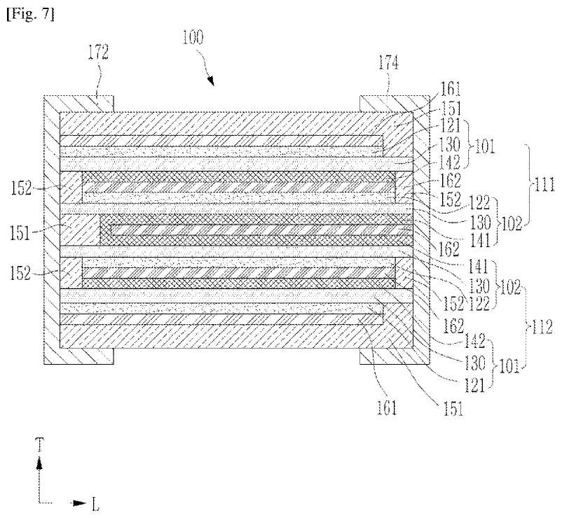

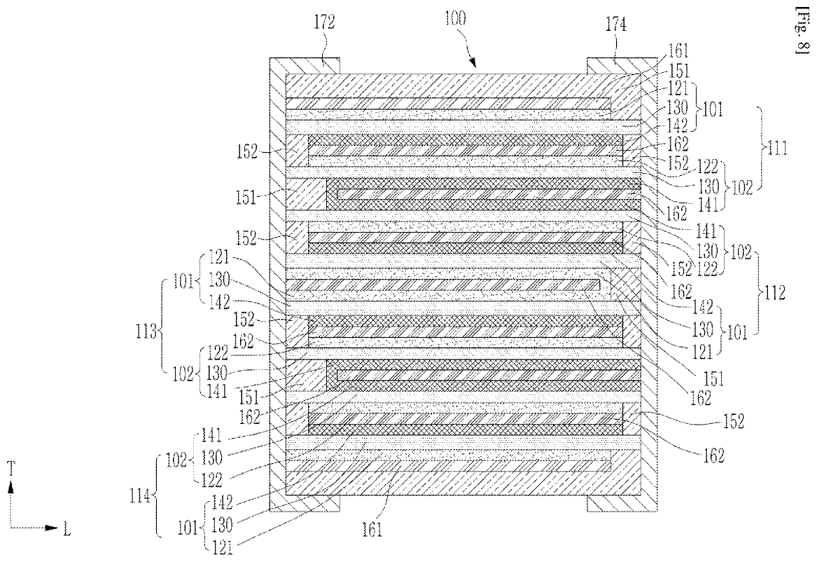

FIG. 7 shows that the first negative electrode active material layers 141 of the first and second unit cells 111 and 112 are wider than the current collecting layer 161 and thus are connected to each other, while surrounding edges of the current collecting layer 161. In addition, the first positive electrode active material layers 121 of the first and second unit cells 111 and 112 are wider than the current collecting layer 161 and thus are connected to each other, while surrounding edges of the current collecting layer 161.

In addition, the all-solid-state battery 100 may include two or more unit cells, and each unit cell may be connected to each other in parallel.

In FIG. 8, the first unit cell 11I is connected with the second unit cell 112 in parallel, the third unit cell 113 is connected in parallel with the second unit cell 112, and the fourth unit cell 114 is connected in parallel with the third unit cell 113.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
101, 102, 103: first to third unit cells
111, 112, 113, 114: first to fourth unit cells
121, 122: first and second positive electrode active material layers
130: solid electrolyte layer
141, 142: first and second negative electrode active material layers
151, 152: first and second margin layers
161: current collecting layer
162: internal current collecting layer
174, 172: first and second external electrodes

### INDUSTRIAL APPLICABILITY

The present disclosure relates to an all-solid-state battery.

One aspect of the embodiment provides an all-solid-state battery capable of implementing a high-voltage battery.

1. An all-solid-state battery having first and second side surfaces facing each other and comprising:
a first unit cell including:
a first positive electrode active material layer including a first margin layer in one side direction close to the first side surface,
a second negative electrode active material layer including a second margin layer in the one side direction and the other side direction, and
a solid electrolyte layer disposed between the first positive electrode active material layer and the second negative electrode active material layer in a stacking direction; and
a second unit cell including:
a second positive electrode active material layer including a second margin layer in the one side direction and the other side direction,
a first negative electrode active material layer including a first margin layer in the other side direction close to the second side surface, and
a solid electrolyte layer disposed between the second positive electrode active material layer and the first negative electrode active material layer in the stacking direction,
wherein the first unit cell and the second unit cell am connected in series.

2. The all-solid-state battery of claim 1, wherein
the second negative electrode active material layer of the first unit cell and the second positive electrode active material layer of the second unit cell are disposed adjacent to each other in the stacking direction with an internal current collecting layer interposed therebetween.

3. The all-solid-state battery of claim 2, wherein
the internal current collecting layer includes second margin layers in the one side direction and the other side direction.

4. The all-solid-state battery of claim 3, wherein
the second margin layers are disposed along an edge of one or more of the second positive electrode active material layer, the second negative electrode active material layer, and the internal current collecting layer.

5. The all-solid-state battery of claim 1, wherein
an average length in the one side direction of the first margin layer of the first positive electrode active material layer is longer than an average length in the one side direction of the second margin layer of the second negative electrode active material layer.

6. The all-solid-state battery of claim 5, wherein
a ratio of the average length in the one side direction of the first margin layer of the first positive electrode active material layer to the average length in the one side direction of the second margin layer of the second negative electrode active material layer is 1.2:1 to 2:1.

7. The all-solid-state battery of claim 1, wherein
an average length in the other side direction of the first margin layer of the first negative electrode active material layer is longer than an average length in the other side direction of the second margin layer of the second positive electrode active material layer.

8. The all-solid-state battery of claim 7, wherein
a ratio of the average length in the other side direction of the first margin layer of the first negative electrode active material layer to the average length in the other side direction of the second margin layer of the second positive electrode active material layer is 1.2:1 to 2:1.

9. The all-solid-state battery of claim 1, wherein
the first margin layer and the second margin layer have ionic conductivity of less than or equal to 1.0×10¹⁰ S/cm.

10. The all-solid-state battery of claim 9, wherein
the first margin layer and the second margin layer include an electrolyte material or an insulating material.

11. The all-solid-state battery of claim 1, wherein
the solid electrolyte layer includes an inorganic solid electrolyte including an oxide-based solid electrolyte, a sulfide-based solid electrolyte, or a combination thereof.

12. The all-solid-state battery of claim 1, further comprises: a third unit cell including:
a second positive electrode active material layer including a second margin layer in the one side direction and the other side direction,
a second negative electrode active material layer including a second margin layer in the one side direction and the other side direction, and
a solid electrolyte layer disposed between the second positive electrode active material layer and the second negative electrode active material layer in the stacking direction,
wherein the third unit cell is disposed between the first unit cell and the second unit cell.

13. The all-solid-state battery of claim 12, wherein
the third unit cell is serially connected to the first unit cell and the second unit cell, respectively.

14. The all-solid-state battery of claim 1, further comprising a first external electrode disposed on the second side surface, and a second external electrode disposed on the first side surface.

15. The all-solid-state battery of claim 14, further comprising:
a current collecting layer disposed adjacent to the first positive electrode active material layer in the stacking direction, wherein the current collecting layer extends in the one side direction and is connected to the second external electrode, and
another current collecting layer disposed adjacent to the first negative electrode active material layer in the stacking direction, wherein the another current collecting layer extends in the one side direction and is connected to the first external electrode.

16. An all-solid-state battery having first and second side surfaces facing each other, and comprising
a first unit cell including a first positive electrode active material layer including a first margin layer in one side direction close to the first side surface, a second negative electrode active material layer including a second margin layer in the one side direction and the other side direction, and a solid electrolyte layer disposed between the first positive electrode active material layer and the second negative electrode active material layer in a stacking direction, and
a second unit cell including a second positive electrode active material layer including a second margin layer in the one side direction and the other side direction, a first negative electrode active material layer including a first margin layer in the other side direction close to the second side surface, and a solid electrolyte layer disposed between the second positive electrode active material layer and the first negative electrode active material layer in the stacking direction,
wherein the all-solid-state battery includes two or more unit cells in which the first unit cell and the second unit cell are connected in series.

17. The all-solid-state battery of claim 16, wherein
the unit cells are connected in parallel.

18. The all-solid-state battery of claim 17, wherein
in the unit cells, each of the first positive electrode active material layers is disposed adjacent to each other in the stacking direction with a current collecting layer interposed therebetween, or in the unit cells, each of the first negative electrode active material layers is disposed adjacent to each other in the stacking direction with a current collecting layer interposed therebetween.

19. The all-solid-state battery of claim 18, wherein
the first positive electrode active material layers or the first negative electrode active material layers of each of the unit cells are wider than the current collecting layer and are connected to each other while surrounding an edge of the current collecting layer.

20. The all-solid-state battery of claim 17, wherein
in the unit cells, each of the first positive electrode active material layers is disposed adjacent to each other in the stacking direction, or
in the unit cells, each of the first negative electrode active material layers is disposed adjacent to each other in the stacking direction.

21. An all-solid-state battery comprising:
first and second external electrodes spaced apart from each other; and
one or more unit cells, each including:
an internal current collecting layer spaced apart from the first and second externa electrodes;
a second negative electrode active material layer disposed on one surface of the internal current collecting layer,
a second positive electrode active material layer disposed on another surface of the internal current collecting layer opposing the one surface of the internal current collecting layer;
a first solid electrolyte layer, a first positive electrode active material layer, and a first current collecting layer sequentially disposed on the second negative electrode active material layer, and
a second solid electrolyte layer, a first negative electrode active material layer, and a second current collecting layer sequentially disposed on the second positive electrode active material layer,
wherein the first current collecting layer is connected to the first external electrode, and the second current collecting layer is connected to the second external electrode, and
the internal current collecting layer is closer to the first external electrode than the second current collecting layer, and is closer to the second external electrode than the first current collecting layer.

22. The all-solid-state battery of claim 21, wherein the one or more unit cells includes a first unit cell and a second unit cell stacked on each other such that the second current collecting layer of the first unit cell is the same as the second current collecting layer of the second unit cell.

23. The all-solid-state battery of claim 21, wherein
each unit cell further includes:
another solid electrolyte layer, another positive electrode active material layer, and another internal current collecting layer sequentially disposed between the second positive electrode active material layer and the second solid electrolyte layer, and
the another internal current collecting layer is spaced apart from the first and second externa electrodes.

24. The all-solid-state battery of claim 21, wherein
the second current collecting layer includes one end connected to the second external electrode and another end, opposing the one end,
covered by the first negative electrode active material layer.
